(19) United States
(12) Patent Application Publication
(10) Pub. No.: US 2017/0156350 A1
(43) Pub. Date: Jun. 8, 2017

(54) POWDER COMPOSITION FOR AN AERATED FOOD PRODUCT

(71) Applicant: FrieslandCampina Nederland B.V., Amersfoort (NL)

(72) Inventors: Paul Bastiaan VAN SEEVENTER, Amersfoort (NL); Albert Thijs POORTINGA, Amersfoort (NL); Abhay Vasant MARKANDE, Amersfoort (NL); Nicolaev Luben ARNAUDOV, Vlaardingen (NL); Simeon Dobrev STOYANOV, Vlaardingen (NL)

(73) Assignee: FrieslandCampina Nederland B.V., Amersfoort (NL)

(21) Appl. No.: 15/313,595

(22) PCT Filed: May 26, 2015
(86) PCT No.: PCT/NL2015/050374

§ 371 Date: Nov. 23, 2016

(30) Foreign Application Priority Data
May 26, 2014 (EP) 14169866.2

(51) Int. Cl. A21D 10/00; A23C 9/154; A23F 5/40; A23G 1/56; A23G 9/52; A23P 30/40; A23L 2/39; A23L 2/40; A23L 9/10; A23L 29/20; A23L 33/00; A23P 10/35; A21D 8/02; A23K 50/00

(52) U.S. Cl. CPC A21D 10/005; A21D 8/025; A23C 9/1544; A23F 5/40; A23G 1/56; A23G 9/52; A23K 50/00; A23L 2/39; A23L 2/40; A23L 9/10; A23L 29/20; A23L 33/30; A23L 33/40; A23P 10/35; A23P 30/40; A23V 2002/00

(57) ABSTRACT

The invention relates to a gas release agent comprising particles of a water-soluble or water-dispersible material containing voids wherein pressurised gas is entrapped, which particles are at least partially coated with a coating material comprising a hydrophobic substance and/or an amphiphilic substance, said amphiphilic substance having an HLB-value of 8 or more. The invention further relates to a food composition comprising the gas release agent and to a food made from a food composition comprising the gas release agent.

The invention relates to gas release agent, to a powder composition for preparing a food product comprising said gas release agent, to a method for preparing said powder composition, to a method for preparing a food product from said powder composition, to a food product obtainable by said method, and to a method for keeping gas bubbles in bulk liquid.

Various food products can be prepared by the addition of water to a powder mixture to dissolve or disperse the powder mixture and prepare the food products. A popular kind of such food products are powdered instant food products. The food product is prepared by simply mixing the powder with (hot) water, resulting in a ready-to-consume product. Thus instant food products allow, e.g., consumers (or vendors or vendor-machines) to prepare the food product in a fast and simple manner.

Examples of powdered instant food products are instant soup powders, instant infant formulae, and instant coffee products.

In various applications it is desirable to provide an instant powder that allows the preparation of a food product that contains gas bubbles, such as a foam layer on top of the product (e.g. cappuccino) or in the bulk of the product. There are various reasons of why this may be desired, such as visual appearance, organoleptic sensations (e.g. taste, mouthfeel, scent) or even dietary reasons (less caloric value per volume).

Thus, there is also a need to provide instant products that allow the preparation of an instant food product, such as a beverage, which food product contains a means to release gas bubbles when mixed with water.

The prior art gives numerous examples of dry powders that create a foam layer on top of the beverage (typically for cappuccino-type instant coffee powders). WO 2006/023564 A1, for instance relates to a powder that releases gas when mixed with water to create a beverage. These powders can be used to create a foam layer, for example to produce a cappuccino-like foamy, frothy layer on top of coffee.

An example of a cold-soluble foamer for providing a food product with a foam layer on top of the product is found in WO 2010/071425. A powdered foaming composition is provided that contains entrapped gas. The foaming agent comprises a phospholipid.

EP 1 797 772 A1 describes a self-foaming liquid culinary aid, comprising a first liquid component comprising an acid, and a second liquid component comprising an edible salt for the preparation of food products wherein gas bubbles are dispersed throughout the bulk of the products (e.g. aerated yoghurt or jam).

Powdered instant compositions for preparing such food products would be advantageous, e.g. in view of shelf-life. However, no commercially available instant powdered products are known.

WO 2013/034520 A1 relates to a powder composition suitable for forming a foam upon reconstitution in a liquid, comparing a foamer ingredient that releases gas bubbles upon reconstitution in water and a thickening agent. The thickening agent can be any suitable compound capable of increasing the viscosity and keeping the bubbles dispersed in the liquid. Most preferably the thickening agent is pregelatinised starch. No details are give about specific properties of the thickening agent, other than its capability of increasing the viscosity and keeping the bubbles dispersed.

It would be desirable to have an alternative for the use of starch as a means to maintain the bubbles dispersed in the bulk of the product. For instance, starch is a polysaccharide with a high glycaemic index and it adds to the caloric value of the product. Further, the thickening properties of starch are not always desirable. Further a side-effect of starch may be a slimy mouth-feel which is not appreciated by all consumers.

WO 2013/034520 A1 also shows an Example for preparation of a coffee product using an unspecified xanthan gum, an unspecified guar gum or lambda carrageenan MV306 It is unclear which guar gum or xanthan gum was used. The present inventors found that reconstitution of an instant coffee drink powder comprising a commercially available foamer (a gas release agent containing entrapped pressurised gas) and a xanthan gum commercially available as Keltrol RD, resulted in a drink wherein a thick foam layer on top of the bulk formed within less than 10 min.

It is an object of the present invention to provide an (alternative) gas releasing agent, in particular a gas release agent for use in powder composition suitable for the preparation of an instant food product such as
coffee and other coffee-based beverages;
chocolate milk and other cocoa-based beverages;
fruit and/or vegetable-based beverages;
fluid dairy products, other than fluid ice-cream and liquid dairy products labelled as weight management meal replacers;
dry dairy products, other than dry powder dairy products labelled as weight management meal replacers;
infant nutrition products;
bakery and confectionary products;
toppings and desserts, other than ice-cream;
animal feeds;
pet food products;
clinical nutrition food products (i.e. food products for use in enhancing, maintaining or restoring health and/or prevent a disease, prescribed by a health care professional like a physician, nurse, or dietician, and destined for and supplied to persons in need thereof).

In particular, the present invention aims to provide a gas release agent, in particular for use in an instant powder composition for preparing a food product, such as a beverage, another liquid food product or a spoonable food product, with satisfactory organoleptic properties, which food product contains gas bubbles dispersed in the bulk of the product and wherein the gas bubbles remain in bulk within a time period which is long enough for the consumer to consume the food composition.

More in particular, it is an object to provide such a composition which after reconstitution in an aqueous liquid forms an aerated product wherein gas bubbles are dispersed in the bulk of the product, which product imparts a creamy mouth-feel, in particular a mouth-feel resembling fat globules, when consumed.

The inventors have found that it is possible to provide a gas release agent, which can be an ingredient of a powder composition suitable for preparing a food product comprising gas bubbles dispersed in a continuous phase wherein the bubbles—a discontinuous phase—are dispersed by combining a specific gas release agent and one or more other instant food components, in particular a flavour component, wherein the gas release agent is provided with a specific coating material.

Accordingly, the invention relates to a gas release agent comprising particles of a water-soluble or water-dispersible material containing voids wherein pressurised gas is entrapped, which particles are at least partially coated with a coating material comprising a hydrophobic substance and/or an amphiphilic substance, said amphiphilic substance having an HLB-value of 8 or more.

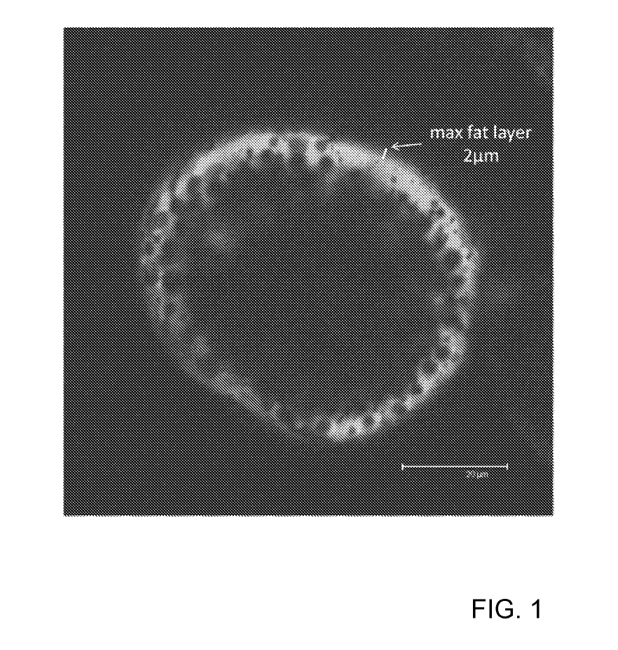

FIG. 1 shows a CARS picture of a non-agglomerated gas release agent of the invention.

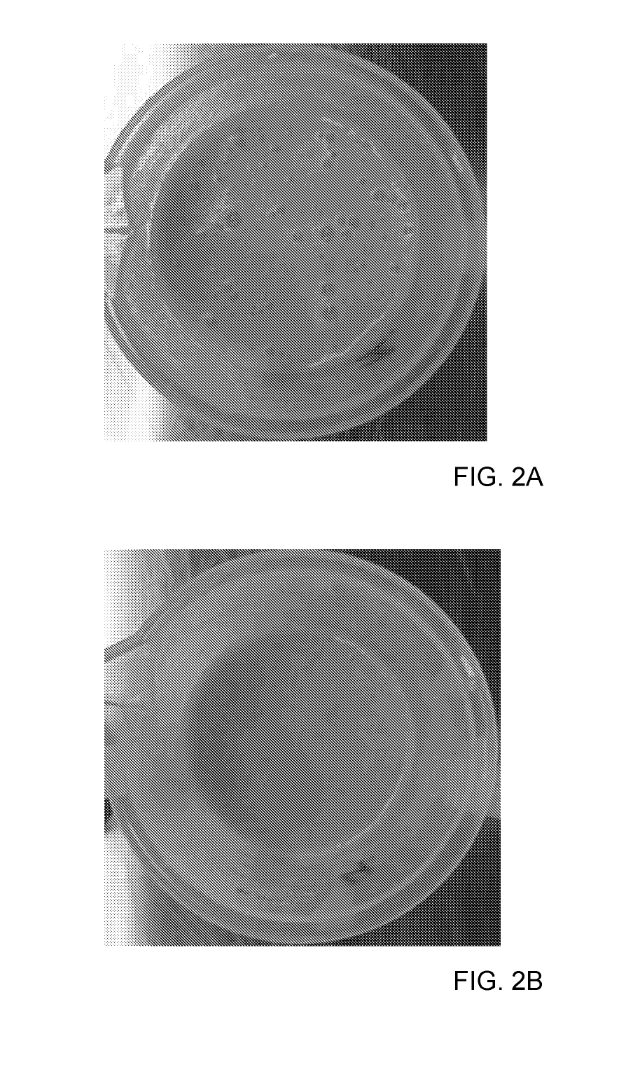

FIG. 2 shows a top view of a food product (soup) made using a gas release agent according to the invention and a comparative product.

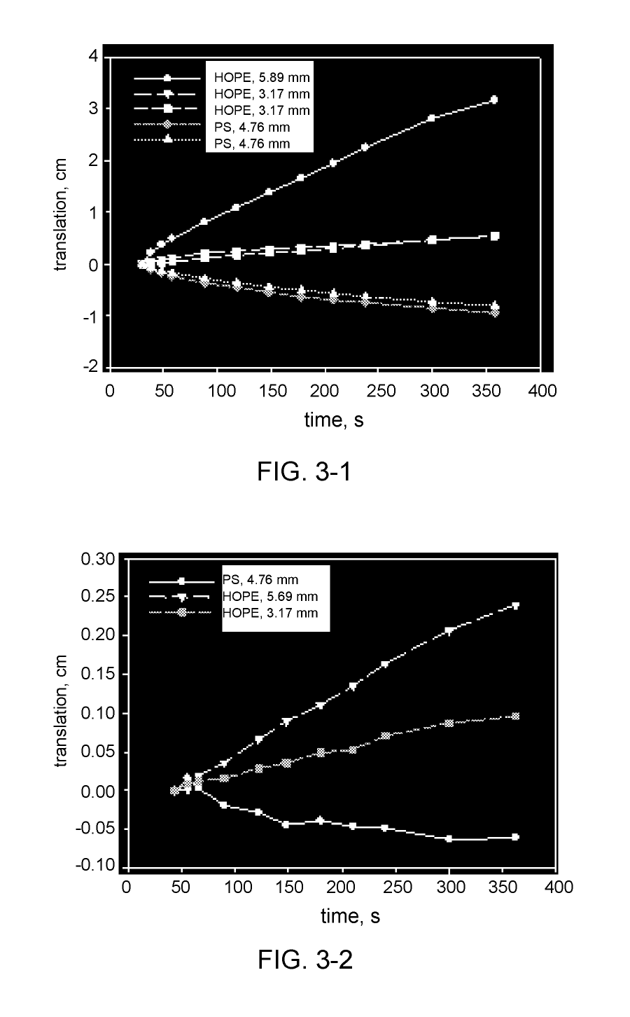

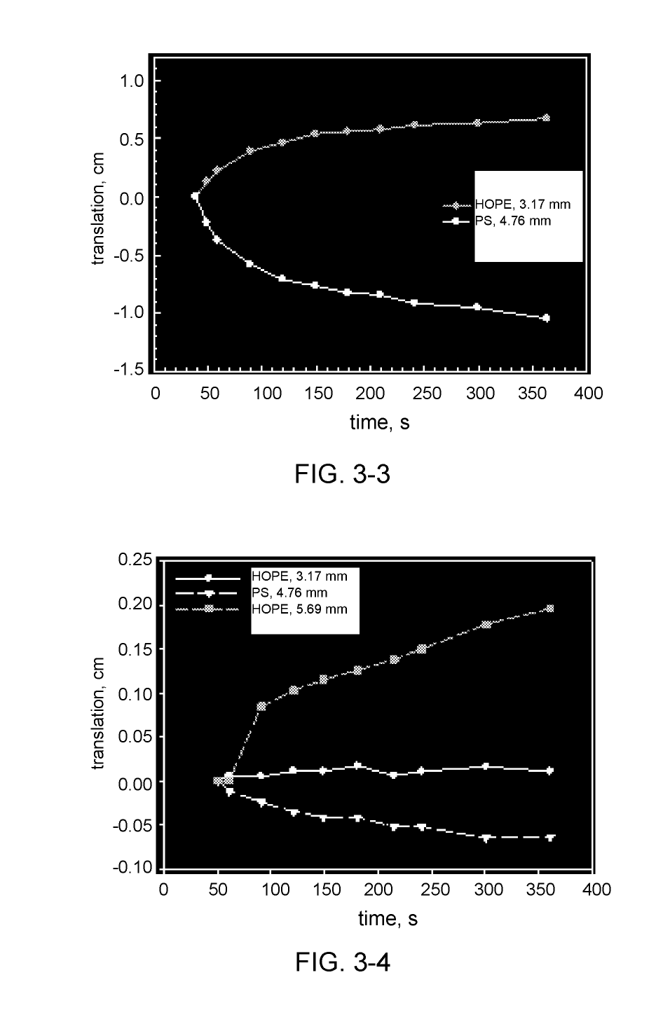

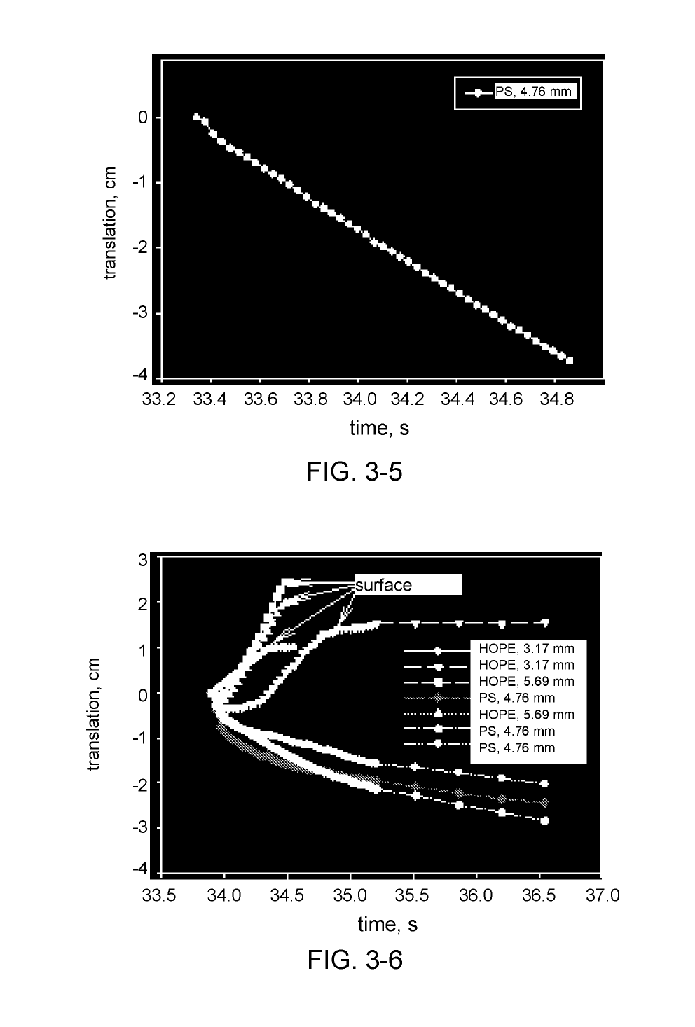

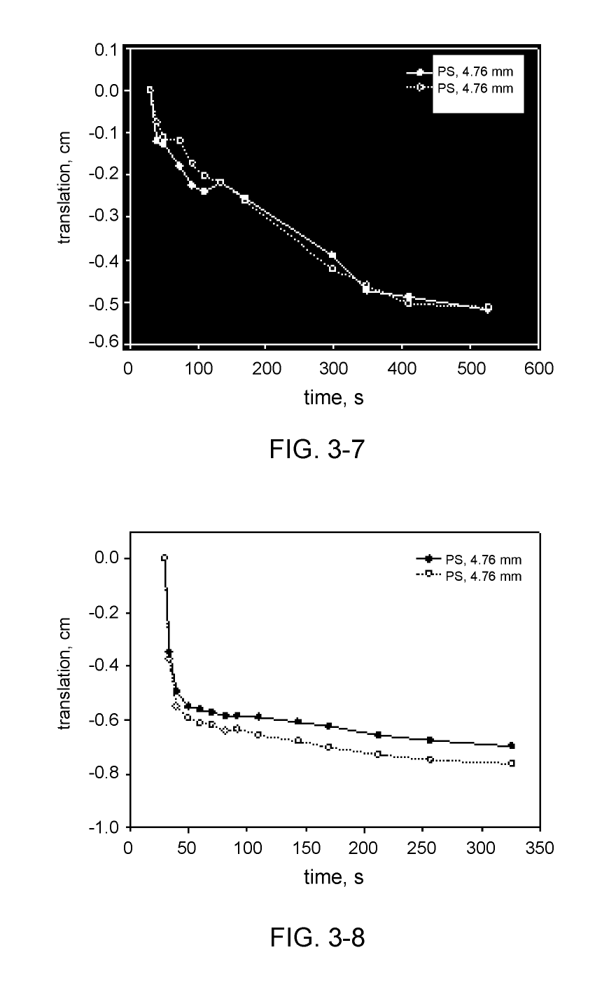

FIG. 3 shows various plots useful in the determination of yield stress.

The term “coating material” is used herein for a substance present on the surface of the gas release agent or to be provided on the surface of the gas release agent, which substance is solid at room temperature, i.e. the substance has structural rigidity and resistance to changes of shape or volume at room temperature. The coating material on the surface of the gas release agent typically covers at least a substantial part of the surface of the gas release agent, typically 30-100%, preferably more than 50%, more preferably at least 80%, in particular at least 90% or at least 95%.

The term ‘hydrophobic substance’ is used herein for substances that are essentially insoluble in water, such as medium chain triglycerides (MCT, chain length of 6-12 carbons) and long chain triglycerides (LCT, chain length of more than 12 carbons). In particular, essentially insoluble in water is to be understood as having a solubility in water at 20° C. of less than 0.5 wt. %, more in particular less than 0.1 wt. % A hydrophobic substance typically has a low HLB-value, in particular of less than 3, more in particular of 0-1.

The term ‘amphiphilic substance’ is used herein for a substance comprising both an hydrophilic group and a hydrophobic group, wherein the HLB-value is 8 or more, in particular 9 or more. Preferably, the HLB of an amphiphilic coating material is 10 or more, more preferably 11 or more, more preferably 12 or more, in particular about 15 or more. The upper limit is not particularly critical. Usually, the HLB value of the amphiphilic substance is 20 or less, in particular 19 or less, more in particular 18 or less. In particular, good results have been achieved with an amphiphilic substance having an HLB of about 17 or less.

As used herein, the HLB-value is the value as determinable as described in ‘CLASSIFICATION OF SURFACE-ACTIVE AGENTS BY “HLB”’, by William C. Griffin in the JOURNAL OF THE SOCIETY OF COSMETIC CHEMISTS, p316-326, presented at the Oct. 11, 1949, Meeting, Chicago Chapter, Chicago III; available on internet via: http://journal.scconline.org/pdf/cc1949/cc001n05/p00311-p00326.pdf.

The gas release agent in accordance with the invention is a gas-containing gas release agent. It contains a gas phase entrapped in a matrix material, which matrix material is solid at room temperature. Thus, the matrix material generally holds the gas in one or more internal voids (closed pores) in the matrix material. The gas-containing gas release agent is typically a particulate product composed of particles containing closed pores in which the gas phase is present. Usually, such porous particles are prepared by a spray drying technique applying gas injection in a liquid feed to be atomise d typically via the use of a high pressure atomisation nozzle.

The gas release agent of the present invention comprises particles containing a pressurised gas, i.e. having a pressure of more than 1.0 bara, in particular of 1.5 bara or more, more in particular 2-30 bara. In a specific embodiment, the gas pressure is 2.0-10 bara. Gas release agents containing pressurised gas are e.g. known from WO 2006/023564, EP 2 025 238 A1 and references cited therein. Other examples of gas release agents containing particles holding a gas are given in EP-A 1538924, WO 2006/023565 and US 2011/0212242.

The gas in a gas-containing gas release agent may be any gas that is used in the context of food products, such as air, oxygen, nitrogen, carbon dioxide, nitrous oxide, or mixtures of these. Preferably the gas is nitrogen or a mixture of nitrogen and oxygen, such as air.

The solid matrix material of the gas release agent particles may comprise any edible solid material. In a preferred embodiment, the matrix material comprises at least a component selected from the group of carbohydrates and proteins. In a preferred embodiment, the matrix material is composed of carbohydrate and protein for at least 50 wt. %, in particular for 80-100 wt. % more in particular 95-100 wt. %.

Particularly suitable as a source for the protein for the solid material of the gas-containing gas release agent are milk proteins such as skim milk powder, whey protein concentrate, whey powder, caseinate, and the like.

Preferred carbohydrates for the gas release agent include oligosaccharides obtainable by hydrolysing starch (hydrolysed starches), in particular hydrolysed starches having a DE of 10-45, glucose syrup, maltodextrins and lactose. nOSA-starch (n-octenyl succinyl anhydride modified starch of “hydrophic” starch) is another preferred carbohydrate.

In an advantageous embodiment, the solid matrix material for the gas release agent at least substantially consists of a carbohydrate, in particular a maltodextrin and/or nOSA starch. In a specific embodiment, the carbohydrate content of the gas release agent is 90-100% based on dry weight. In a further specific embodiment the matrix material is a combination of maltodextrin and nOSA starch, wherein maltodextrin is the major component (>50 wt. % of the matrix material) and nOSA the minor component (<50 wt. % of the matrix material), such as a combination of about 90 wt. % maltodextrin and about 10 wt. % nOSA starch.

In a further advantageous embodiment, the solid matrix material for the gas release agent comprises a protein, optionally in combination with a carbohydrate, in particular a maltodextrin. The presence of a protein is advantageous at least in some applications in that it may contribute to bubble-dispersion properties of the product.

In a specific preferred embodiment, the gas release agent comprises pressurised gas, in particular air or nitrogen, and the matrix material is formed by a protein and a maltodextrin, plus optionally nOSA starch.

In addition to the matrix material and the gas phase entrapped in the matrix material, the gas release agent comprises a coating material and optionally one or more other components.

The presence of a coating material has been found advantageous in that it contributes to an improved entrapment of gas bubbles in the bulk of the food product prepared in accordance with the invention.

The matrix material and the coating material are generally present in distinct physical phases, which phases together, and optionally with one or more other phases, form particles with a hierarchical structure. In this specification, particles with a hierarchical structure are particles which are composed of two or more physical phases which physical phases are generally solid at room temperature. The phases may be bound to each other by physical or chemical interaction at their contacting surfaces.

Typical examples of hierarchical structures in a product according to the invention are coated or encapsulated particles.

The matrix material is typically the major component of the gas release agent, usually providing more than 50 wt. % of the gas release agent's total weight (i.e. including coating material and optionally present other component(s)), preferably at least 85 wt. %, more preferably at least 92 wt. %, in particular at least 95 wt. % or at least 97. wt. %. The matrix material content of the combination, is usually 99.9 wt. % or less, preferably 99 wt. % or less, in particular 97 wt. % or less, more in particular 95 wt. % or less.

The physical state of the gas release agent particles, including coating material is typically essentially solid at room temperature.

Accordingly, the coating material generally has a melting point above room temperature. Preferably, it has a melting point or melting range above 40° C., more preferably in the range of 40-200° C., in particular in the range of 50-190° C., more in particular in the range of 50-180° C.

The gas release agent is degradable in (hot or cold) water, i.e. at least a substantial part thereof, preferably essentially all of the gas release agent disintegrates when contacted with a sufficient amount of water of a suitable temperature. As a result of contact with water, the phase comprising the coating material disintegrates, for instance by melting of at least a significant part of this phase or by dispersing/dissolving of a significant part of this phase. Thus, the gas release agent is allowed to be adequately contacted with the water or other aqueous liquid, such that it disintegrates and gas is released into the aqueous liquid.

Advantageously, the coating material, optionally in combination with other components, is considered to offer protection of the gas release agent against its environment, in particular during storage, thereby having a positive influence on the shelf life of the product. However, also in an embodiment wherein a substantial part of the surface of the gas release agent particles is not covered with another material, such as in an agglomerate, a satisfactory shelf-life is achieved, whilst contributing to good gas release properties.

A coating comprising the coating material may be relatively thin and is thought to be effective also if not the complete surface of the matrix material is covered. A high relative amount of coating material will increase particle size, due to an increased thickness of the coating layer, and in particular a relatively high amount of the coating material may increase the tendency to form agglomerates, Further, it is considered that, when introduced into a fluid, the gas release agent may start to rise towards the surface of the fluid, if its overall density is less than the density of the fluid. The rising rate typically increases with a reduction of the overall density and with an increase in particle/agglomerate size. A fast rising rate is generally not desired, and therefore the total weight of the coating material, is usually less than 20 wt. %, based on the weight of the matrix material. In particular, the amount of coating material can be about 15 wt. % or less, based on the weight of the matrix material, preferably 10 wt. % or less, in particular 5 wt. % or less, more in particular 3 wt. % or less, more in particular 2 wt. % or less or 1 wt. % or less.

The amount of coating material usually is at least 0.1 wt. %, based on the weight of the matrix material, preferably at least 0.8 wt. %, more preferably at least 1 wt. %, in particular at least 2 wt. %, more in particular at least 5 wt. %.

In terms of coating thickness, a coating thickness of less than 20 μm, preferably of 10 μm or less, in particular of 5 μm or less, more in particular of 2 μm or less on at least a substantial part of the particles' surface is sufficient. Usually, the coating has an average thickness of at least about 0.3 μm, preferably of at least 0.5 μm, more preferably of at least 0.6 μm. In particular, good results have been achieved with a coated gas release agent wherein at least a substantial part of the coating has a thickness of about 1 μm or more.

Moreover, the inventors found that—surprisingly—one or more additional components of the gas release agent, in particular the coating material, may contribute in a positive manner to a foam property. In general, the coating material of the gas release agent in a composition according to the invention contributes to entrapment of the gas bubbles in the bulk if a powder composition of the invention is reconstituted in water or another aqueous fluid. Thus, the coating materials generally share a gas-bubble entrapment improver function.

It is in particular contemplated that a hydrophobic coating material or a amphiphilic coating material contribute to an improved entrapment of bubbles in the bulk due to a delay in substantial gas release, compared to a otherwise similar gas release agent that is free of a coating. For amphoteric coating materials, it is further contemplated that they have a stabilising effect in that bubbles are kept relatively small, which makes them easier to entrap.

In particular, good results have been achieved with a gas release agent comprising a hydrophobic coating material. The hydrophobic coating material is generally non-amphoteric. Preferably, the hydrophobic coating material is at least substantially free of a substance comprising phosphate groups or quaternary ammonium groups, such as phosphatidcylcholine or lecithin. In experiments carried out by the inventors such substances appeared to be non-functional with respect to contributing to an improved entrapment of bubbles in the bulk of the liquid.

A hydrophobic coating material is preferably provided on a gas release agent wherein the matrix material is at least substantially composed of one or more hydrophilic substances, such as one or more substances selected from the group of carbohydrates and proteins.

Hydrophobic coating materials include waxes and fats, such as triglycerides, hydrophobic fatty acids, phytosterols, phtyostanols, hydrophobic fatty acid esters, hydrophobic alchols, carotenoids, hydrophobic vitamins, hydrophobic flavours, hydrophobic fragrances, hydrophobic colourants. Typically the hydrophobic coating material is solid at room temperature. Preferably, the hydrophobic coating material is selected from the group of triglycerides and waxes. If a triglyceride is present usually the triglyceride is a triglyceride of one or more fatty acids having a chain length of at least 6, preferably of 12-24. In order to provide a solid coating material composed of one or more triglycerides typically the coating material comprises a sufficient amount of triglycerides that are solid at room temperature, such as saturated C12-C24 glycerides. Preferred hydrophobic triglyceride mixtures that are solid at room temperature and suitable as coating materials are palm fat (hardened palm oil), butter fat, cocoa butter and coconut fat (hardened coconut oil) and palmkernel fat. Good results have been achieved with hardened palm oil (palm fat).

If present, the total content of hydrophobic coating material of the gas release agent usually is at least 15 wt. %, preferably at least 30 wt. %, in particular at least 50 wt. %, more at least 60 wt. %, based on the total weight of components of the gas release agent other than the matrix material. The content may be 100% or less, in particular 98 wt. % or less, more in particular 95 wt. % or less, more in particular 90 wt. % or less, e.g. 80 wt. % or less, based on the total weight of components of the gas release agent other than matrix material.

A fatty acid, a monoglyceride or diglyceride may also be provided as a hydrophobic coating material instead of or in addition to a triglyceride, provided that the fatty acid is essentially uncharged at the pH of the fluid in which the gas release agent is dissolved. This is particularly surprising, since fatty acids, like most other emulsifiers such as monoglycerides and diglycerides, are generally considered as detrimental to foam properties, such as foam stability.

The fatty acid salt is usually selected from bivalent metal fatty acid salts, in particular alkaline earth metal fatty acid salts, preferably calcium fatty acid salts and magnesium fatty acid salts.

The fatty acid part of the salt is usually selected from fatty acids having 6-24 carbon atoms, preferably 12-18 carbon atoms. The fatty acid can be an unbranched or branched fatty acid. The fatty acid can be saturated or unsaturated.

Other examples of suitable fatty acid salts are sorbates, octanoates, decanoates, dodecanoates, myristates, isostearates, oleates, linoleates, linolenates, ricinoleates, behenates, erucates, palmitates, eicosapentaenoates and docosahexaenoates. Evidently, the fatty acid salt may be mixture of fatty acid salts. For instance, the mixture may be obtained by saponification of a natural fat mixture, e.g. from coconut oil, palm oil, olive oil or other vegetable oils, fish oil, whale blubber, tallow and/or other animal fats.

The amphiphilic substance can be a polymeric or non-polymeric surface active substance. Good results have been achieved with a non-polymeric surface active substance.

If present, the total content of amphiphilic substance of the gas release agent, usually is at least 15 wt. %, preferably at least 30 wt. %, in particular at least 50 wt. %, more at least 60 wt. %, based on the total weight of components other than the matrix material of the gas release agent. The content may be 100% or less, preferably 98 wt. % or less, in particular 90 wt. % or less, more in particular 80 wt. % or less, based on the total weight of components other than matrix material in the gas release agent.

Suitable amphiphilic substances in particular include sugar esters and esters of a mono- or diglyceride and an organic acid, and amphiphilic esters of fatty acids. The number of ester bonds may be chosen between 1 and the number of hydroxyl-functionalities of the sugar. Thus, for a sucrose ester the number of ester bonds is in the range of 1-8. For the purpose of this invention the term sugar fatty acid ester is intended to include both single compounds and mixtures of single compounds. Commercially, food-grade sugar fatty esters may be obtained from suppliers like Mitsubishi-Kagaku (Tokyo, Japan) or Sisterna (Roosendaal, Netherlands).

Preferred sugar esters are sucrose esters. The sugar ester, such as the sucrose ester, preferably is a sugar ester selected from the group of stearate esters and palmitate esters.

A preferred mono- or diglyceride ester is an ester of citrate, e.g. Citrem® (having an HLB of 11).

Preferred amphiphilic esters of fatty acids encompass lactic acid (including the sodium and/or calcium salts) esters of fatty acids, such as sodium stearoyl-2-lactylate (SSL).

In a preferred embodiment, at least 72 wt %, more preferably at least 74 wt % of the sucrose fatty acid esters comprises sucrose monostearate or sucrose monopalmitate or a combination thereof. Preferably, from 10 to 90 wt %, more preferably from 20 to 80 wt % of the total amount of the sucrose fatty acid esters is sucrose monostearate. Preferably, from 10 to 90 wt %, more preferably from 20 to 80 wt % of the total amount of the sucrose fatty acid esters is sucrose monopalmitate. Preferably, the combined amount of sucrose fatty acid monoesters and sucrose fatty acid diesters comprised in said sucrose fatty acid esters is at least 75 wt %, preferably at least 80 wt %, more preferably at least 85 wt % and still more preferably at least 90 wt % of the total amount of sucrose fatty acid esters.

The gas release agent can be prepared based on technology known per se. The matrix material containing the voids with pressurised gas can be obtained in a manner described in the prior art cited herein, such as WO 2006/023564. The provision of the coating material can be done in a manner known per se for the specific coating material.

Generally, the method of preparing the gas release agent comprises—contacting particles of a water-soluble or water-dispersible matrix material containing voids wherein pressurised gas is entrapped with the coating material; and

applying the coating material (in solid or fluid form) on at least part of the surface of said particles.

In a specific embodiment, the coating material is provided on the matrix material as a powder coating. It is not necessary that essentially all of the surface of the matrix material is coated with or encapsulated in the coating material. A substantial part of the surface of the matrix material may remain uncovered with the coating material. It is contemplated that this may be favourable for a relatively fast reconstitution rate, when preparing a food composition from the powder composition

In an advantageous embodiment, the gas release agent is provided with the coating material using a high shear mixer (e.g. Cyclomix by Hosokawa), wherein the particles of the matrix material containing the voids are mixed with the coating material. As an alternative to high shear mixing, the coating material may be sprayed onto the matrix material, e.g. in a fluidized bed.

The mixing of coating material and matrix material is advantageously carried out above ambient temperature (25° C.). The temperature can be below the melting temperature or range of the coating material, e.g. up to 15° C. below the melting temperature or range; in an embodiment the contacting takes place at about the melting point or at a temperature within the melting range of the coating material; in a further embodiment the contacting comprising contacting above the melting point or range of the coating material provided that the matrix material remains intact and does not release an unacceptable amount of gas during mixing at such temperature. Good results have in particular been achieved with a method wherein the contacting comprises contacting at a temperature in the range of about 45 to about 60° C., in particular with a coating material having a melting point or range in the range of about 55 to about 60° C.

Preferably the gas release agent releases at least 1 millilitre of gas (when reconstituted in water having a temperature of 85° C., at 1 bara pressure, hereafter referred to as ‘standard conditions’), per gram of dry gas release agent, more preferably the gas release agent releases at least 2 millilitre of gas at standard conditions per gram of dry gas release agent, even more preferably at least 5 ml per gram of dry gas release agent, in particular at least 10 ml per gram of dry gas release agent. Usually, the gas release agent releases 20 ml gas per gram of dry gas release agent or less, when reconstituted in water, in particular.

Usually, the amount of water to the amount of gas release agent, based on the gas volume at 1 bara and 25° C. provided by the gas release agent when all gas is released is at least 1 ml gas/100 ml liquid product (i.e. 1% overrun), preferably said amount ranges from 5 ml gas/100 ml liquid product (i.e. 5% overrun) to 100 ml gas/100 ml liquid product (i.e. 100% overrun).

The gas-containing gas release agent may further contain one or more plasticizers to improve the robustness of the solid matrix material. If present, the plasticizers are preferably selected from the group consisting of polyols or sugar alcohols, such as glycerol, mannitol, sorbitol, lactitol, erythritol, trehalose and/or lipids other than fat, such as fatty acids or monoglycerides, phospholipids. However, good results have been obtained with a gas release agent that is essentially free of plasticisers.

In particular, the gas release agent may further include additional stabilizing agents to increase the dispersion stability of the bubbles in the bulk of the food product, to stabilise pH or to prevent protein from flocculation (after reconstitution).

Preferred stabilisers are sodium or potassium citrates and orthophophates.

Further, a free flowing aid may be present, preferably silicon dioxide or tricalcium phosphate.

The presence of an emulsifier (in addition to or as an alternative to an emulsifying protein) may be advantageous to facilitate dispersion of gas bubbles. If present, the emulsifier preferably has a HLB-value of at least 7, preferably at least 10. Typically, the emulsifier has a HLB of less than 20, in particular of 18 or less. Alternatively or additionally, the instant food ingredient contains an emulsifier, in order to readily disperse the gas bubbles. If an additional emulsifier is desired, sodium stearoyl-2-lactylate or a sucrose ester, for example sucrose ester SP70 supplied by Sisterna, may in particular be present.

The gas-containing gas release agent usually has a loose bulk density of at least 150 g/l. Usually the loose bulk density is 520 g/l or less, in particular in the range of 300-500 g/l, more in particular 420-470 g/l. A density within this range can be obtained by the person skilled in the art using known technology. For instance use can be made of gas injection into the aqueous feed slurry just before atomisation, which is done preferably with nitrogen gas. This allows preparation of products of such lower densities. Such particles typically have porous structures, in particular containing voids in the range of 1-30 micron.

The particle size of the gas release agent amongst others has an effect on the buoyancy of the particles in the fluid in which it is introduced when used to prepare a food product for consumption. It is desired that the gas release agent at least substantially remains inside the fluid phase wherein it disintegrates (rather than quickly rising to the surface before it disintegrates).

Preferably, at least 90 wt. % of the coated gas release agent particles (D₉₀) is formed by particles having a size less than 400 μm, more preferably essentially all particles have a size of less than 400 μm, as determined by a screen test method, using a 400 μm screen.

Preferably, at least 90 wt. % of the coated gas release agent particles is formed by particles having a size of 30 μm or more, as determined by a screen test method, using a 30 μm (400 mesh) screen.

In particular, good results have been achieved with a coated gas release agent having a D₁₀ in the range of 30-70 μm, a D₅₀ in the range of 100-200 μm and a D₉₀ in the range of 250-350 μm.

Although the coated gas release agent may be an agglomerated particulate product, good results have been achieved with an essentially non-agglomerated particulate gas release agent (e.g. as shown in FIG. 1).

The invention further provides a powder composition suitable for preparing a food product comprising gas bubbles dispersed in a continuous phase, the powder composition comprising a gas release agent according to the present invention, and one or more instant food ingredients. The powder composition of the invention is suitable for preparing a food product selected from the group of
coffee and other coffee-based beverages;
chocolate milk and other cocoa-based beverages;
fruit and/or vegetable-based beverages;
fluid dairy products, other than fluid ice-cream and liquid dairy products labelled as weight management meal replacers;
dry dairy products, other than dry powder dairy products labelled as weight management meal replacers;
infant nutrition products;
bakery and confectionary products;
toppings and desserts, other than ice-cream;
animal feeds;
pet food products;
clinical nutrition food products (i.e. food products for use in enhancing, maintaining or restoring health and/or prevent a disease, prescribed by
   a health care professional like a physician, nurse, or dietician, and destined for and supplied to persons in need thereof,
   the powder composition comprising a gas release agent according to the invention and one or more instant food ingredients.

In general, upon reconstitution of the powder composition in an aqueous fluid, the gas release agent particles disintegrate and release gas bubbles, and the formed gas bubbles are entrapped in the continuous phase.

The weight fraction of the gas release agent in the powder composition is usually at least 5 wt. %, based on dry weight, preferably at least 10 wt. %. The weight fraction of the gas release agent is usually 50 wt. % or less, preferably 30 wt. % or less.

The gas release agent content of a powder composition according to the invention usually is at least 1 wt. %, based on total weight, preferably at least 5 wt. %, in particular at least 10 wt. %, more in particular at least 25 wt. % or at least 50 wt. %. The gas release agent content of a powder composition according to the invention usually is 95 wt. % or less, preferably 90 wt. % or less, in particular 80 wt. % or less. In a specific embodiment, the gas release agent content is 50 wt. % or less.

The powder composition of the invention preferably comprises a hydrocolloid. The hydrocolloid in the powder composition is reconstitutable in water or another aqueous liquid thereby thickening the fluid and entrapping gas bubbles which are released in the liquid by the addition of water to the gas release agent. The hydrocolloid content of the powder composition usually is 5 wt. % or less, in particular 3 wt. % or less.

A liquid is able to suspend gas bubbles if it contains a polymer (hydrocolloid, polysaccharide, thickener, etc.) that can form a weak network, thus providing a sufficient yield stress. The yield stress opposes the buoyancy force, which is responsible for bubbles' creaming in gas dispersions or foams. An increase in the viscosity of the aqueous phase containing the gas bubbles would not be sufficient to stop their creaming but would just slow it down proportionally to the viscosity increase.

Preferably the hydrocolloid provides an apparent yield stress of at least 0.3 Pa within a period of 30 seconds after mixing with water to reconstitute the hydrocolloid. Preferably the hydrocolloid provides an apparent yield stress of at least 0.3 Pa within a period of 15 seconds, preferably within a period of 10 seconds after the addition of water to reconstitute the hydrocolloid. Importantly the hydrocolloid develops the yield stress rapidly enough to entrap the gas bubbles that are released by the dissolution of the gas release agent in added water. Preferably the hydrocolloid provides an apparent yield stress of at least 0.5 Pa, preferably at least 0.7 Pa, preferably at least 1 Pa, within a period of 30 seconds after the addition of water to reconstitute the hydrocolloid. More preferred the hydrocolloid provides an apparent yield stress of at least 0.5 Pa, preferably of at least 0.7 Pa, preferably at least 1 Pa, preferably at least 1.5 Pa, within a period of 15 seconds, preferably 10 seconds, after the addition of water to reconstitute the hydrocolloid. Preferably the yield stress that is obtained within a period of 30 seconds is maximally 5 Pa, preferably 4.5 Pa, preferably 4 Pa. Preferably the yield stress that is obtained within a period of 15 seconds is maximally 5 Pa, preferably 4.5 Pa, preferably 4 Pa. The value of the yield stress of the product is the yield stress at 23° C. The yield stress may be determined based upon the information disclosed herein, in particular in Example 4. In particular if the product is intended for consumption at a different temperature, the yield stress preferably also has a minimum or maximum value as mentioned herein at that temperature. Therefore these yield stresses preferably are determined at the temperature of the liquid that is added to the dry particulate mixture.

In particular, good results have been achieved with an optional hydrocolloid, which forms a thixotropic fluid after reconstitution in water, at least in the presence of the other ingredients for the food product, at consumption temperature. In general, a hydrocolloid is preferred that is suitable to provide a thixotropic composition, when reconstituted in water at a temperature of 25° C. Such hydrocolloids are also referred herein as ‘thixotropic’. The advantage of using a thixotropic compound, is that it does not give a slimy mouthfeel. Preferably, a solution or dispersion of 0.5 g/L or less of the hydrocolloid in water of 25° C. is thixotropic, in particular a solution or dispersion of the hydrocolloid of about 0.2 g/l or less, e.g. about 0.1 g/L. Preferably the optional hydrocolloid has a hydration rate in water at a temperature of 23° C. at a concentration of 1 wt % and a volume weighted mean diameter D4,3 of the hydrocolloid ranging from 40 to 200 micrometer, of less than 3 minutes. Definitions of these parameters are provided in WO 2012/030651 A1. The contents of WO 2012/030651 A1 are incorporated by reference.

Preferably the optional hydrocolloid in particulate form comprises a xanthan gum, wherein the xanthan gum has a hydration rate in water at a temperature of 23° C. at a concentration of 1 wt % and a volume weighted mean diameter D4,3 of the hydrocolloid ranging from 40 to 200 micrometer, of less than 3 minutes. Preferably the hydrocolloid has a hydration rate of less than 2 minutes. Preferably the xanthan gum has a hydration rate of less than 2 minutes. Preferably, the hydrocolloid comprises a thixotropic xanthan gum.

Preferably the optional hydrocolloid comprises particles having a volume weighted mean diameter D4,3 ranging from about 5 micrometer to 150 micrometer, more preferred from about 10 micrometer to 130 micrometer. Preferably the dry hydrocolloid comprises particles having a volume weighted mean diameter D4,3 ranging from 40 to 200 micrometer, preferably from 50 to 150 micrometer, more preferably from 60 to 90 micrometer. Preferably the dry optional hydrocolloid comprises particles having a Sauter mean diameter D3,2 ranging from 10 to 100 micrometer, preferably from 20 to 70 micrometer, more preferably from 20 to 50 micrometer.

Preferably the optional hydrocolloid comprises a xanthan gum, having the following properties in solution at 23±2° C.:
a hydration rate of less than 3 minutes in a 1 wt % NaCl solution at a 1 wt % concentration of xanthan gum; and
an ability to fully hydrate in less than 10 minutes in a 6 wt % NaCl solution at a 1 wt % concentration of xanthan gum.

Preferably the hydrocolloid comprises xanthan gum, preferably xanthan gum obtained from the fermentation of Xanthomonas campestris pathover campestris, deposited with the American Type Culture Collection (ATCC) under the accession no. PTA-11272. The fermentation requires a nitrogen source, a carbon source and other appropriate nutrients known to the skilled person, and described in WO 2012/030651 A1. The hydrocolloid preferably comprises the xanthan gum as described and defined in WO 2012/030651 A1. A preferred xanthan gum is Keltrol AP or Keltrol AP-F, supplied by CP Kelco (Nijmegen, Netherlands). Most preferred is the xanthan gum Keltrol AP-F, supplied by CP Kelco (Nijmegen, Netherlands).

Advantages of using the preferred xanthan gum, are that the xanthan gum not only rapidly provides the required yield stress, and that additionally the xanthan gum provides this effect independent of the water temperature. Therefore the water temperature for mixing with the powder composition in particulate form of the invention may have a broad range. Opposite to this, especially native starches mostly need water at high temperature to gelatinise, at least at a temperature above the gelatinisation temperature. Moreover the required amount of the preferred xanthan gum is lower than for example starches of the prior art.

The Hydration Rate is determined in the following way, using a hydration rate tester. Hydration Rate is defined as the amount of time for the sample to reach 90% of maximum torque using a torque load cell. While this does not directly measure full hydration, the 90% point is a useful metric for sample comparison. The 100% point obtained is more variable since the approach to the final value is gradual and is affected by even small amounts of random error in the measurement. The instrument utilises a variable speed motor to stir the solvent in a beaker that is mounted to a torque sensing load cell. The xanthan gum is added to the solvent while mixing at a constant speed to begin the test. As solution viscosity builds due to the hydration of the xanthan gum, the torque (twisting force) on the beaker increases. The torque values are continuously monitored by a computer which normalises, prints and plots the data in terms of percentage torque versus time. While torque is not a direct measure of the viscosity of the sample, torque provides a valuable measure of the viscosity development over time.

Hydration Rate Procedure: The test uses 80 mesh particle size xanthan gum, which is dispersed in polyethylene glycol (PEG) at a weight ratio of 3:1 and hand mixed at room temperature (23±2° C.). Samples to be tested are mixed with the dispersant immediately before the test is started. Standard tap water is prepared by dissolving 1.0 g of NaCl and 0.15 g CaCl₂.2H₂O in 1 liter of de-ionised water. A volume of 130 mL is used in a 250 mL stainless steel beaker. Xanthan gum is tested at 1 wt %. The stirrer is a H-bar stirrer with the following dimensions: overall length 20.3 cm, length to cross member 17.8 cm, 3.8 cm×3.8 cm in ‘H’ (0.64 cm stainless dowel used). The H-bar stirrer has a 2-4 mm clearance from the bottom of the cup in order to mix the solution while maintaining a vortex in the solution. The direction of the ‘H’ is upright, and a shaft is connected to the ‘horizontal bar’ of the ‘H’. The stirrer speed is set at 600 rpm. The sample is added over a 4-5 second period of time in a very controlled and constant fashion. For consistency and accuracy, the sample must not be added too fast or slow or in an uneven manner. The data are scaled from 0 to 100% of the maximum torque that occurs during the test. The time to reach 90% of maximum torque is taken as the Hydration Rate. This value is found to be stable and repeatable.

If the powder composition of the invention comprises one or more hydrocolloids, then preferably at least 25 wt % of the total hydrocolloid content in the powder composition in particulate form is formed by the preferred optional hydrocolloid, preferably one or more thixotropic hydrocolloids, preferably the preferred xanthan gum. More preferred at least 50 wt % of the total hydrocolloid content in the dry powder composition is formed by the preferred hydrocolloid, preferably one or more thixotropic hydrocolloids, preferably the preferred xanthan gum.

The powder composition in particulate form of the invention may comprise one or more native starches. Preferably the one or more native starches originate from potato. Such native starches may be combined with the preferred optional hydrocolloid as described before. In case such combination of hydrocolloids is present in the powder composition in particulate form, then less than 25% of the total hydrocolloid content in the powder composition in particulate form may be formed by the preferred optional hydrocolloid. Preferably the amount of the preferred hydrocolloid according to the invention is smaller than the amount of the one or more native starches. Preferably the total ratio of the amount of preferred optional hydrocolloid, and the one or more native starches ranges from 1:5 to 1:10 wt/wt.

The combination of the preferred optional hydrocolloid, preferably comprising a xanthan gum, combined with one or more native starches, is that these hydrocolloids enforce each other's functionality. The concentration of both types of materials can be decreased as compared to their single use.

The powder composition further comprises an instant food component, i.e. the food ingredients other than the hydrocolloid and the gas release agent. This component is suitably selected from any known food ingredients for use in a specific application, e.g. instant coffee for a coffee-based food product or cocoa for a cocoa-based product. The instant food ingredients are in particular selected from the group of flavours, aromas, nutrients (protein, carbohydrate, fats, minerals, vitamins, trace elements, antioxidants, etc.), acidulants, stabilizing agents, colourants.

The amount(s) of the food ingredient(s) can suitably be chosen based upon common general knowledge, the information disclosed herein the content of the cited prior art and optionally a limited amount of routine testing.

Usually, the total amount of the instant food component forms more than 1 wt. %, based on dry weight of the powder composition, in particular at least 10 wt. % more in particular at least 15 wt. %. Usually the total amount of the instant food component is 90 wt. % or less, in particular 60 wt. % or less, more in particular 40 wt. % or less.

The weight ratio of the instant food component (i.e. the total of instant food ingredients other than the gas release agent and the hydrocolloid in the powder composition) to the gas release agent usually is at least 0.01, preferably at least 0.02, in particular at least 0.03, more in particular at least 0.05. Usually, the weight ratio of the instant food component to the gas release agent is 20 or less, preferably 5 or less, in particular 1 or less, more in particular 0.5 or less.

The weight ratio of the hydrocolloid to the instant food component usually is at least 0.005, preferably at least 0.05, in particular at least 0.10. The weight ratio of the hydrocolloid to the instant food component usually is 10 or less, preferably 5 or less, in particular 1 or less, more in particular 0.5 or less, even more in particular 0.3 or less.

Preferably the powder composition has a moisture content of at most 5%.

The invention further provides a food product made by or obtainable by reconstituting a powder composition according to the invention in an aqueous liquid.

A preferred food composition according to the invention is a coffee drink, such as a milk coffee. Further, preferred products include soft drinks, juices, infant and toddler food, chocolate drinks, desserts and milk drinks.

Preferred desserts are selected from the group of puddings, vla, liquid yoghurts, non-liquid yoghurts, and cottage cheese.

Preferred spoonable products are whipped cream, mousse, cottage cheese and (non-fluid) yoghurt, such as Turkish-style yoghurt.

In a method for preparing a food composition according to the invention, the powder composition is typically mixed with water or another aqueous liquid, e.g. milk. The aqueous liquid may be poured onto the powder composition (present in a cup or other holder from which the product can be consumed). Alternatively the powder composition is added to the aqueous liquid.

The temperature of the aqueous liquid used in a method for preparing a food composition according to the invention is typically in the range of 0-100° C. The aqueous liquid preferably has a temperature that allows immediate consumption of the product. Thus, in particular for a product to be consumed hot preferably hot liquid is used, such as a temperature in the range of 60-100° C., in particular in the range of 70-95° C. In particular for a product that is to be consumed at room temperature or below, the temperature of the liquid preferably is in the range of 0-30° C., in particular in the range of 4-25° C.

Usually, the weight to weight ratio powder composition to water is in the range of 1:200 to 1:1. In particular said ratio is at least 1:30. In particular, said ratio is 1:5 or less.

In a specific embodiment, the powder composition is for preparation of a food product, in particular a beverage, in a vending machine. Accordingly, in a specific embodiment, the invention extends to a vending machine comprising a powder composition according to the invention, respectively to a method for preparing a food composition comprising mixing the powder composition with water to provide the food composition, in particular the beverage.

Usually, the concentration of the hydrocolloid in a food product containing gas bubbles in the bulk according to the invention is at least 0.1 mg/g product, preferably at least 0.5 mg/gram product. It is an advantage of the present invention that a relatively low amount of the hydrocolloid suffices to retain bubbles in the bulk of the product. A concentration of 5 mg/g or less is usually sufficient. Preferably the concentration of the hydrocolloid is 2 mg/g product or less.

In an embodiment, the powder composition according to the invention is prepared by dry-blending the gas release agent in particulate form, the hydrocolloid in particulate form and the food component in particulate form.

In a further embodiment the powder composition is prepared by providing a blend of the gas release agent in particulate form and the hydrocolloid in particulate form and said blend is dry-blended with the food component in particulate form.

Suitable dry-blending methods are known in the art and include dry blending, dry extrusion and dry tumbling, agglomeration or granulation.

A powder composition according to the invention, comprising at least the gas release agent (a) and the instant food ingredient (c), can be used to provide a food product, ready for consumption, by mixing it with an aqueous liquid.

When the powder composition is reconstituted in an aqueous liquid, bubbles are introduced the liquid, as gas is released by the gas release agent. The bubbles are dispersed in the aqueous phase (continuous phase), whereby a food product is provided having an internal foamed texture. Typically, essentially throughout the food product bubbles are entrapped in the continuous phase. In contrast, in beverages like cappuccino or beer essentially all bubbles formed in the bulk rise to the top relatively quickly to form (foam) froth on top of the product.

A powder composition according to the invention has been found particularly suitable to be dissolved or dispersed (i.e. reconstituted) in an aqueous liquid to provide a food product, such as a fluid food product or a spoonable food product, wherein bubbles remain dispersed in the bulk of the product for a sufficiently long time to prepare, serve and consume the product.

A food product according to the invention (obtainable by a preparing a food product by reconstituting the powder composition of the invention in an aqueous liquid) contains gas bubbles dispersed in the bulk of the food product is selected from the group of
coffee and other coffee-based beverages;
chocolate milk and other cocoa-based beverages;
fruit and/or vegetable-based beverages;
fluid dairy products other than fluid ice-cream and liquid diary products labelled as weight management meal replacers;
dry dairy products, other than dry powder dairy products labelled as weight management meal replacers
infant nutrition products;
bakery and confectionary products;
toppings and desserts, other than ice cream;
animal feeds;
pet food products;
clinical nutrition food products.

Preferably, the food product maintains gas bubbles throughout the bulk of the product for at least 10 minutes preferably at least 15 minutes, preferably at least 20 minutes, preferably at least 30 minutes, after its preparation.

Usually, the gas bubbles constitute at least 1% of the volume of the food, preferably at least 3% of the volume of the food, in particular at least 5% of the volume of the food, more in particular at least 10% of the volume of the food. Usually, the gas bubbles constitute 50% or less of the volume of the food product, in particular 40% of the volume of the food product or less.

The invention is in particular advantageous, in that it provides a product wherein at least 90% of the gas volume, is formed by gas bubbles having a diameter of 300 micrometer or less, preferably 200 micrometer or less. Preferably, this is the case for at least 5 min, more preferably at least 10 min, more preferably at least 30 min after preparation of the food product.

Usually, at least 90% of the gas volume in a food product of the invention is formed by gas bubbles having a diameter 10 micrometer or more, in particular of at least 40 micrometer, more in particular of at least 50 micrometer.

In a further aspect the present invention provides a method for keeping gas bubbles in bulk liquid by using a hydrocolloid in particulate form that provides an apparent yield stress of at least 0.3 Pa, preferably of at least 0.5 Pa, within a period of 60 seconds after the addition of water to reconstitute the hydrocolloid. Preferred embodiments disclosed in the context of this invention, are applicable here, mutatis mutandis.

Further, the invention relates to a method for keeping gas bubbles in bulk liquid, wherein the gas bubbles are generated using a gas release agent according to the invention in the presence of a hydrocolloid in the bulk liquid.

In a preferred embodiment, the food product has an organoleptic property that is appreciated by consumers, not only because of the sensation given by the presence of bubbles but also in that the product imparts a creamy mouth-feel, in particular a mouth-feel resembling fat globules, when consumed.

Further, the invention is in particular advantageous in that it allows the preparation of a fluid food product wherein bubbles remain dispersed in the bulk, and which food product preferably has a creamy mouthfeel, at a relatively low viscosity of the product. To this effect, preferably use is made of a hydrocolloid of which a solution or dispersion in water shows thixotropic behaviour.

Further, the invention provides a powder composition for preparing a food product (fluid or spoonable) wherein bubbles remain dispersed in the bulk, wherein the concentration of the hydrocolloid, contributing to maintaining the bubbles in the bulk for a prolonged time, is relatively low to obtain a dispersion-stabilising effect, compared to—e.g.—a thickening agent, such as starch, disclosed in WO 2013/034520 A1.

Further, the invention is advantageous in that it may have an enhanced taste or smell, compared to a similar product wherein the bubbles are absent. Thus the concentration of flavours, such as salt or sugar, or aroma's may be reduced to impart a similar taste or scent sensation.

Unless defined otherwise, all technical and scientific terms used herein have the same meaning as commonly understood by one of ordinary skill in the art.

All percentages, unless otherwise stated, refer to the percentage by weight. The abbreviation ‘wt %’ refers to percentage by weight. In case a range is given, the given range includes the mentioned endpoints.

Average particle sizes are generally expressed as the volume weighted mean diameter D4,3. The volume based particle size equals the diameter of a sphere that has the same volume as a given particle. Alternatively the average particle size may be expressed as the D3,2, which is the Sauter mean diameter. D3,2 is defined as the diameter of a sphere that has the same volume/surface area ratio as a particle of interest.

Gas volumes are given at a temperature of 20° C. and a pressure of 1 atmosphere (1.01325 bara), unless indicated otherwise.

Room temperature is 23±2° C.

The term “or” as used herein means “and/or” unless specified otherwise.

The term “a” or “an” as used herein means “at least one” unless specified otherwise.

The term “substantial(ly)” or “essential(ly)” is generally used herein to indicate that it has the general character or function of that which is specified, for instance when referring to essentially spherical it means that it has at least the general appearance of a sphere. When referring to a quantifiable feature, these terms are in particular used to indicate that it is for more than 50%, in particular at least 75%, more in particular at least 90%, even more in particular at least 95% of the maximum that feature. When referring to an amount-related feature, the amount in terms of weight is meant, unless specified otherwise,

When referring to a “noun” (e.g. a compound, an additive etc.) in singular, the plural is meant to be included, unless specified otherwise.

For the purpose of clarity and a concise description features are described herein as part of the same or separate embodiments, however, it will be appreciated that the scope of the invention may include embodiments having combinations of all or some of the features described

The term ‘hot’ in relation to a beverage is generally understood in the art. Typically, ‘hot’ means a temperature of at least 50° C., in particular 60-100° C., more in particular 80-95° C.

Further, definitions for various products are:

Milk: milk originating from a mammal, preferably originating from a cow, sheep, goat, horse, more preferably originating from a cow.

Dairy ingredient: any ingredient selected from the group of milk proteins (i.e. casein, caseinate, whey proteins), hydrolysates of milk proteins, milk fats and lactose.

Dairy-based food product: milk or any (processed) food product containing or made, obtained or derived from milk and milk products other than milk, or milk derivatives, either alone or combined with another (agricultural) product, and wherein the total content of dairy ingredients is more than 0.1%. Dairy-based food products in particular include milk, dairy-cream, butter milk, kefir, kumis/airag, milk powder (powdered milk), condensed milk, khava, evaporated milk, ricotta cheese, infant formulae (liquid and powder), dried milk powder, butter, cheese produced by co-agulating milk, casein, whey and/or whey fractions, yoghurt and other fermented milk products, and other milk products.

Ice-cream: frozen food product, intended for consumption at a temperature below 0° C. that contains water and sugar. Ice-cream may further contain dairy ingredients, fruit, fruit juice, fruit extracts, flavours, and other ingredients like nuts and chocolate.

Fruit and/or vegetable-based beverages, are beverages comprising a substance from fruit or beverage, in particular fruit pieces, vegetable pieces, fruit juice, or vegetable juice. The total content of substances from fruit or beverage in the fruit and/or vegetable based beverage generally is at least 0.5 wt. %, in particular at last 2 wt. %, more in particular at least 5 wt. %. The content of ingredients originating from dairy milk is typically lower than 0.1% by weight, and the content of soy ingredients (soy protein, soy carbohydrate, soy fat) is typically lower than 0.1% by weight.

Beverage or (liquid) food composition for weight management (weight management meal replacer): food products that are marketed to aid the consumer to lose weight or at least not to increase weight. These products usually are packaged in a package containing a claim (label) that they can aid the consumer to loose weight. Thus, products labelled as weight management meal replacers are intended for use in aiding a consumer to lose weight or at least not to increase weight. These products may contain ingredients originating from milk. A beverage or (liquid) food composition for weight management preferably reduces in an individual the desire to eat a meal or a snack, preferably increases satiety of the individual, preferably produces an enhanced feeling of ‘fullness’.

Clinical nutrition food products: food products for use in enhancing, maintaining or restoring health and/or prevent a disease, prescribed by health care professional like a physician, nurse, or dietician, and destined for and supplied to persons in need thereof.

The following examples illustrate the present invention.

### EXAMPLES

### Example 1

Preparation of a Coated Gas Release Agent According to the Invention

As starting product (uncoated gas release agent) a gas release agent as described in WO 2006/023564 was used. This product can be obtained from FrieslandCampina Kievit under the name Vana Cappa B01. The product consists of a powder containing 88 wt. % of maltodextrin 18DE, 8 wt. % of n-OSA starch and 4 wt. % of silicon dioxide. The powder matrix contains entrapped pressurised nitrogen gas.

The production of coated gas release agent was done in high shear mixer (Cyclomix by Hosokawa Micron BV, Doetinchem, The Netherlands). The starting product was heated to 45° C. in the high shear mixer. Then 10% of hydrophobic coating material (palm fat, the product marketed by Loders as Revel A) was added to the starting product. The blend was heated to 55° C. and mixing was continued for 25 minutes. After 25 minutes of mixing, the powder mixture is cooled down to room temperature.

Using CARS (Coherent Anti-stokes Raman Spectroscopy) microscopy it was confirmed that the process resulted in with a fat coating (dark) on at least a substantial part of the surface of the matrix material phase of the gas release agent particles, see also FIG. 1. It should be noted that only the outer part of the powder lights up with this technique, because the laser light does not penetrate further in the powder particles.

### Example 2

This Example provides a hot chocolate type of drink. A powder mixture was made consisting of 17 g of instant chocolate mix (supplied by Heimbs) and 0.3 g of Keltrol AP-F (supplied by CP Kelco). To this mixture 3 gram of the following gas-releasing agents were added:

Sample 1: Vana Cappa B01 (supplied by FrieslandCampina—Kievit) coated with 10 wt. % fat (Revel A, a palm fat with a melting point around 60° C. supplied by IOI Loders Croklaan).

Sample 2 (comparative example): Vana Cappa B01.

Sample 3 (comparative example): Vana Cappa B01 coated with Metarin lecithin/hosol 1:1 ratio. The lecithin was supplied by Cargill, the oil was supplied by Loders Croklaan.

Sample 4 (comparative example): Vana Cappa B01 coated with Topcithin NGM lecithin/hosol 1:1 ratio. The lecithin was supplied by Cargill, the oil was supplied by Loders Croklaan.

Sample 5 (comparative example): Vana Cappa B01 containing 10% revel A dispersed in the powder matrix.

Sample 1 was coated in a Cyclomix mixer (supplied by Hosokawa). The Vana Cappa B01 was heated to 55° C. in the mixer. Then the appropriate amount of coating was added to the Vana Cappa B01. The blend was heated to 60° C. and was mixed for 5 minutes. After mixing, the powder mixture was cooled down to room temperature.

Samples 3-4 were coated in a fluidized bed at 50° C. by spray 500 g of the mixture in 20 min on 25 kg of the Vana Cappa B01.

The mixtures were put in glasses (250 ml glass with a diameter of 60 mm). 150 ml of hot (85° C.) water was added to each glass and stirred for 30 seconds. The overruns and foam heights obtained are given in Table 1. Tests were performed about 1 month after production of the samples. At that point in time sample 6 had lost most of its gas. This is explainable because gas is expected to leak through the fat droplets.

TABLE 1

| | | Foam layer at 5 | Foam layer at 15 |
|---|---|---|---|
| Sample | Overrun (%) | min (mm) | min (mm) |
| 1 | 16 | 4 | 4 |
| 2 (comparative) | 17 | 15 | 14 |
| 3 (comparative) | 19 | 12 | 16 |
| 4 (comparative) | 17 | 18 | 20 |
| 5 (comparative) | <10% | — | — |

The above Table shows that coated gas releasing agents in which the coating consists of fat lead to the formation of a much thinner foam layer on top of the bulk phase. However, coated gas releasing agents in which the coating comprises phospholipids on the other hand do give rise to the formation of a thick foam layer on top, most likely because phospholipids do not slow down dissolution.

### Example 3

This Example shows a hot instant aerated drink, in this case a Café Latte type of drink. A powder mixture was made consisting of 2 g of instant coffee, 2 g of Vana Cappa B01 (sample 2 (comparative example)) or 2 g of the fat coated powder of Example 2 (sample 1), 0.3 g of Keltrol AP-F and 6 g of Vana Cappa 25C (supplied by FrieslandCampina Kievit and composed of 25% coconut fat 18% lactose, 54.4% Skim Milk Powder, 0.6% Disodium-phosphate, 0.1% SiO₂).

The mixture was put in a glass (250 ml glass with a diameter of 60 mm). 150 ml of hot (85° C.) water was added and stirred for 30 seconds. The thus produced drinks had an overrun of around 18%. For both samples, no clear layer of foam could be detected about 5 min after preparation, although for sample 2 some diffuse layering was visible. For sample 1, no layering was observed after about 5 min. Further, 15 min after preparation, sample 2 contained a 30 mm thick foam layer whereas for sample 1 still no foam layer could be seen.

### Example 4

Determination of Yield Stress Under Dynamic Conditions.

In this experiment model premixes have been prepared containing the relevant hydrocolloid (either 0.2 g, 0.4 g, or 4 g), together with icing sugar (sucrose, 5.0 gram) and erythritol (2.0 g) to prevent lumping of the dry hydrocolloid. The premix is dry mixed well, and subsequently put into a tall form 300 ml glass beaker.

Three different types of precision plastic spheres (The Precision Plastic Ball Company Ltd., UK) were added to the premix in the beaker. These spheres are:
high density polyethylene (HDPE) spheres, diameter of 3.17 mm coloured green, density of 0.952 g·cm⁻³,
high density polyethylene (HDPE) spheres, diameter of 5.69 mm coloured bright red, density of 0.952 g·cm⁻³,
polystyrene (PS) sphere, diameter of 4.76 mm, coloured dark red, density 1.04 g·cm⁻³.

The size and density of the spheres was chosen in such a way that they would behave like gas bubbles of approximately 0.1 mm (4.76 mm PS sphere), 0.2 mm (3.17 mm HDPE sphere), and 0.3 mm (5.69 mm HDPE sphere). The differences to bubbles are that the terminal velocity of the probe spheres will be an order of magnitude bigger in a Newtonian fluid and that the PS sphere is going to sediment instead of cream.

For the experiments with xanthan gums, 150 g of water at ambient temperature was poured on top of the premix and was vigorously stirred by hand with a metal spoon for 30 seconds. The density of the final solutions was (1.014±0.001) g·cm⁻³. Xanthan gum's behaviour was independent of the water temperature.

For the experiments with modified starches, 150 g of hot water (just after boiling) was poured on top of the premix and was vigorously stirred by hand with a metal spoon for 30 seconds. Here hot water was used, in order to gelatinise the starch and make it functional. The density of the final solutions is (1.023±0.001) g·cm⁻³.

The test is based on the principle that: after the stirring the spheres will be suspended at a certain height in the liquid, and depending of the yield stress generated by the hydrocolloid, they will slowly move upward, or downward, or they will remain at its place. The higher the yield stress, the slower the spheres will move.

The test is carried out as follows:

The beaker is positioned on a stand and pictures are taken at fixed time intervals for 5 minutes. This way the movement of the spheres can be followed in time. The translation of the spheres relative to its starting position can be plotted as function of time in a graph. In case the processes are too fast to be captured on pictures, a video record is made instead.

If there is no yield stress in the system, the spheres will move with a constant velocity through the liquid. If sufficient yield stress is developed by the time the picture taking will have commenced the spheres will stay motionless. If yield stress is developing during the time of the experiments, the spheres' motion is going to be decelerative, i.e. they will slow down and eventually stop moving. The trajectories of the spheres in the experiments described above are measure using video imaging software ImageJ. As a result we get the translation of each type of sphere with time in the studied system.

The following experiments were performed.

TABLE 2
Description of experiments with precision spheres.

| | Hydrocolloid | Hydrocolloid | Hydrocolloid |
|---|---|---|---|
| Exp. | type | amount [g] | concentration* [wt %] |
| 3-1 | Keltrol AP-F | 0.2 | 0.13 |
| 3-2 | Keltrol AP-F | 0.4 | 0.25 |
| 3-3 | Keltrol AP | 0.2 | 0.13 |
| 3-4 | Keltrol AP | 0.4 | 0.25 |
| 3-5 | Keltrol RD | 0.2 | 0.13 |
| 3-6 | Keltrol RD | 0.4 | 0.25 |
| 3-7 | Prejel VA70 | 4.0 | 2.5 |
| 3-8 | Eliane SC160 | 4.0 | 2.5 |

*corrected for the icing sugar and erythritol

The movement of the spheres in each experiment 3-1 till 3-8 has been plotted in various graphs in FIG. 3 (FIGS. 3-1 till 3-8). In some cases duplicate measurements are shown, wherein two similar spheres are followed. In general reproducibility is very good, as the trajectories of these two spheres almost coincide.
In experiment 3-1 the largest sphere translates the most from its initial position, as compared to the other spheres. The smaller spheres only have a small translation.
In experiment 3-2 the concentration of hydrocolloid has doubled, and the spheres nearly do not move. The maximum measured translation is about 0.25 cm. This shows that the yield stress in this system is high enough to suspend the spheres.
In experiment 3-3 the yield stress did not develop rapidly enough to keep the largest sphere suspended, this sphere floated to the surface. The smaller spheres initially show a relatively rapid movement, which then decelerates because of the development of sufficient yield stress to keep the small spheres suspended.
In experiment 3-4 the translation was very small, like in experiment 3-2. The yield stress that develops This shows that the yield stress in this system is high enough to suspend the spheres.
In experiment 3-5 the behaviour of the spheres is different than in the previous experiments. The HDPE spheres rapidly moved to the surface of the liquid, and the PS sphere sedimented within 2 seconds. When the translation of the particle lies on a straight line with a constant slope, this is indicative of typical Newtonian fluid rheology. Keltrol RD does not have any effect on dissolution or yield stress development.
In experiment 3-6 the spheres show similar behaviour as in experiment 3-5, although the time scale is different. the HDPE particles initially accelerate, and after that move with constant velocities until they surface. This is a typical behaviour of probe particles in Newtonian fluid, and this shows that the presence of Keltrol RD in the solution does not lead to the development of yield stress large enough to oppose the buoyancy force acting on the HDPE particles. The PS particles show different behaviour: they initially decelerate and then move at constant velocities. The initial deceleration might be due to the nature of the experiment. In this case the PS particle were thrown into the solution after the video recording had started, i.e. they had some initial non zero velocity when they contacted the solution. Therefore, they decelerated due to the viscous drag of the solution. After the initial period of time all three PS particles moved with the same constant velocity during the time of the measurement, showing the same Newtonian behaviour of the surrounding solution.
In experiment 3-7 the HDPE spheres rapidly moved to the surface of the liquid, while the PS spheres only showed limited movement, as shown in FIG. 3 (duplicate measurement). The yield stress was sufficient to suspend the PS spheres.

Also in experiment 3-8 similar behaviour of the spheres was observed. The HDPE spheres rapidly moved to the surface, while the PS spheres remained suspended during the experiment, see FIG. 3 (duplicate measurement).

Therefore the modified starches can be used to keep spheres suspended in the bulk liquid, at a much higher concentration though than the Keltrol AP and Keltrol AP-F.

### Example 5

Coating of Gas Release Agent with Sucrose Fatty Acid Ester

Gas release agent was coated with 5% sucrose fatty acid ester. This sample was prepared similarly as described in Example 1. The gas release agent was heated to 55° C. in the mixer. Then the appropriate amount of coating material was added to the powder. The blend was heated to 55° C. and mixed for 25 minutes. After mixing, the powder mixture was allowed to cool down to room temperature.

Another sample was prepared containing 5% sucrose fatty acid ester in the bulk of the particles of the gas release agent. A dispersion of 95% maltodextrin and 5% sucrose fatty acid ester was sprayed at a temperature of 80° C. at a rate of around 100 L/h, with simultaneous injection of nitrogen gas close to the nozzle, at a pressure of about 100 bar. Drying was performed at a temperature of 136° C., followed by 55° C. The density of the powder was around 220 g/litre and the average particle size was around 200 micrometer. Subsequently the powder was loaded with gas by loading a vessel with the dry powder and free flowing agent, pressurising with nitrogen at 35 bar and about 30° C. Subsequently the vessel was heated to above 140° C. for at least 15 minutes. Subsequently, the vessel was cooled to about 40° C., and depressurized.

### Example 6

Gas Release Agent Coated with Sucrose Fatty Acid Ester

The bubble size distribution was determined of uncoated gas release agent, and gas release agent coated with 5% sucrose fatty acid ester and gas release agent with 5% sucrose fatty acid ester dispersed in the particle matrix (from Example 5). Dry mixtures were prepared containing 10 gram of dry soup mix 1; 2 gram of the respective gas release agent; and 0.2 gram of xanthan gum (Keltrol AP-F). These powders were well mixed to prepare homogeneous dry mixtures. Immediately thereafter 150 mL of hot water (just after boiling) was added to the mixture and manually stirred for 30 seconds.

The bubble size distribution of samples taken at various times was determined. The results are given in the following table.

TABLE 3
Average bubble size (d3,2) of gas bubbles in mushroom soup containing
coated (5% sucrose fatty acid ester) or 5% sucrose fatty acid ester
dispersed in particle matrix, or uncoated gas release agent.

| | Dispersed 5% | Coated 5% | Uncoated |
|---|---|---|---|
| Time [min] | d3,2 [μm] | d3,2 [μm] | d3,2 [μm] |
| 1 | 143 | 147 | 174 |
| 10 | 195 | 191 | 183 |
| 20 | 208 | 202 | 200 |
| 30 | 195 | 195 | 210 |

This shows that in particular during the first 10 minutes the bubble size of the gas release agents either coated with sucrose fatty acid ester or sucrose fatty acid ester dispersed in the particle matrix is smaller than the size of the bubbles of the uncoated gas release agent. This is in particular interesting, because during this time the consumer will consume the instant soup mix, when it is still warm. Smaller bubbles are advantageous as compared to bigger bubbles, due to its perceived creaminess.

Although the bubble sizes seem to be the same for the two gas release agents containing sucrose fatty acid ester, coating is favourable above dispersion in the matrix. That is because the coating leads to the prevention of the formation of a foam layer on top of the bulk liquid, as the following experiment shows.

Similarly as above, dry mixtures were prepared containing 10 gram of dry soup mix 1; 3 gram of gas release agent coated with 5% sucrose fatty acid ester or gas release agent with 5% sucrose fatty acid ester dispersed in the particle matrix (both from example 2); and 0.2 gram of xanthan gum (Keltrol AP-F). These powders were well mixed to prepare homogeneous dry mixtures. Immediately thereafter 150 mL of hot water (just after boiling) was added to the mixture and manually stirred for 30 seconds. The height of a possible foam layer on top of the liquid was determined at various times. The results are given in the following table.

TABLE 4
Gas retained in millilitre on top of mushroom soup containing
coated (5% sucrose fatty acid ester) or 5% sucrose fatty
acid ester dispersed in particle matrix.

| | Dispersed 5% | Coated 5% |
|---|---|---|
| time [min] | Gas retained [mL] | Gas retained [mL] |
| 1 | 55 | 24 |
| 10 | 47 | 20 |
| 20 | 40 | 18 |
| 30 | 32 | 11 |

The sample with the coated gas release agent did not have any foam on top of the liquid, all gas was retained in the bulk of the liquid. The sample containing gas release agent with dispersed sucrose fatty acid ester had a foam layer on top of the liquid, of about 2 millilitre (5 minutes after addition of water). The gas bubbles were also relatively large, compared to the sample with coated gas release agent. This is illustrated in FIGS. 2A and 2B, showing pictures of the two samples described here, taken from the top, 30 minutes after preparation of the two samples. FIG. 2A shows the presence of relatively large gas bubbles in a foam layer, on top of the mushroom soup containing gas release agent particles with 5% sucrose fatty acid ester dispersed in the particle matrix. FIG. 2B does not show a foamy layer, and no relatively large bubbles, in the mushroom soup containing gas release agent particles coated with 5% sucrose fatty acid ester.

1.-25. (canceled)

26. A gas release agent comprising particles of a water-soluble or water-dispersible material containing voids wherein pressurised gas is entrapped, which particles are at least partially coated with a coating material comprising a hydrophobic substance and/or an amphiphilic substance, the amphiphilic substance having an HLB-value of 8 or more.

27. The gas release agent according to claim 26, wherein the amphiphilic substance has an HLB of more than 10.

28. The gas release agent according to claim 26, wherein the amphiphilic substance is selected from the group of amphiphilic sugar esters, amphiphilic esters of monoglycerides, amphiphilic esters of diglycerides and amphiphilic esters of fatty acids.

29. The gas release agent according to claim 26, wherein the hydrophobic substance is a fat or a wax that is solid at 23° C.

30. The gas release agent according to claim 29, wherein the hydrophobic substance comprises a fatty acid triglyceride.

31. The gas release agent according to claim 26, wherein the coating material forms 1-15 wt. % of the gas release agent.

32. The gas releasing agent according to claim 26, wherein the water-soluble or water-dispersible material comprises at least one component selected from the group consisting of carbohydrates and proteins.

33. The gas release agent according to claim 32, wherein the carbohydrates comprise maltodextrin.

34. The gas release agent according to claim 32, wherein the proteins comprise milk proteins.

35. The gas release agent according to claim 26, that is essentially non-agglomerated.

36. The gas release agent according to claim 26, wherein at least 90 wt. % of the coated gas release agent particles (D₉₀) is formed by particles having a size less than 400 μm, as determined by a screen test method, using a 400 μm screen.

37. The gas release agent according to claim 26, wherein at least 90 wt. % of the coated gas release agent particles is formed by particles having a size of 30 μm or more, as determined by a screen test method, using a 30 μm (400 mesh) screen.

38. The gas release agent according to claim 37, having a D₁₀ in the range of 30-70 μm, a D₅₀ in the range of 100-200 μm and a D₉₀ in the range of 250-350 μm.

39. A powder composition suitable for preparing a food product, comprising gas bubbles dispersed in a continuous phase, the powder composition comprising a gas release agent according to claim 26, and one or more instant food ingredients.

40. The powder composition according to claim 39, wherein the food product is selected from the group of coffee and other coffee-based beverages; chocolate milk and other cocoa-based beverages; fruit and/or vegetable-based beverages; fluid dairy products, other than fluid ice-cream and liquid dairy products labelled as weight management meal replacers; dry dairy products, other than dry powder dairy products labelled as weight management meal replacers; infant nutrition products; bakery and confectionary products; toppings and desserts, other than ice-cream; animal feeds; pet food products; and clinical nutrition food products.

41. The powder composition according to claim 39, further comprising hydrocolloid particles.

42. The powder composition according to claim 41, wherein a hydrocolloid is present selected from the group of gums and pregelatinised starches.

43. The powder composition according to claim 42, wherein the hydrocolloid is a gum selected from the group consisting of xanthan gums, carrageenan gums and guar gums.

44. The powder composition according to claim 39, comprising 5-95 wt. % of the gas release agent and 0.5-5 wt. % hydrocolloid particles.

45. A method for preparing a gas release agent according to claim 26, comprising:
(a) contacting particles of a water-soluble or water-dispersible matrix material containing voids wherein pressurised gas is entrapped with the coating material, and
(b) applying the coating material on at least part of the surface of the particles.
